(19) United States
(12) Patent Application Publication
(10) Pub. No.: US 2019/0172017 A1
(43) Pub. Date: Jun. 6, 2019

(54) TAGGING MEETING INVITEES TO AUTOMATICALLY CREATE TASKS

(71) Applicant: Microsoft Technology Licensing, LLC, Redmond, WA (US)

(72) Inventors: Eva Britta Karolina Burlin, Newcastle, WA (US); Eric Scott Courtemanche, Seattle, WA (US); Haebin Seo, Seattle, WA (US); Ian Dwyer Curry, Seattle, WA (US); Paul David Tischhauser, Redmond, WA (US); Phoebe Eyonnie Ash, Renton, WA (US); Shahil Soni, Seattle, WA (US); Skye Lee Pazuchanics, Duvall, WA (US); SungJae Park, Providence, RI (US); Daniel Sungje Choi, Providence, RI (US); Sara Wiltberger, Santa Clara, CA (US); Teslim Abiodun Alabi, Redmond, WA (US)

(73) Assignee: Microsoft Technology Licensing, LLC, Redmond, WA (US)

(21) Appl. No.: 15/831,255

(22) Filed: Dec. 4, 2017

(51) Int. Cl. G06Q 10/10

(52) U.S. Cl. CPC G06Q 10/1095; G06Q 10/1097

(57) ABSTRACT

Systems and methods are disclosed for automatically generating a calendar event for a task associated with a meeting. The disclosed systems and methods may include receiving an indication to create a meeting with at least one invitee. At least one invitee is assigned a task from an agenda associated with the meeting. When an invitee is assigned a task, a time slot is automatically added to the invitees' calendar.

### BACKGROUND

Using an electronic application to schedule meetings is common practice in and among businesses and other groups. However, for many invitees, more is required than mere attendance at the meeting. For example, some invitees may be required to prepare presentation materials, complete assigned action items prior to the meeting, or otherwise be prepared to discuss the meeting topics.

As provided herein, a “meeting organizer” is any person who initiates a meeting using an electronic scheduling system. An agenda, or task list, is a list of tasks associated with the meeting for discussion or completion before the meeting. In the example described, a meeting organizer initiates a meeting using an electronic scheduling system and invites at least one invitee. The meeting may include an agenda with at least one task that is assigned to at least one invitee.

With conventional systems, the meeting organizer is responsible for initiating a meeting request and providing an agenda, which may include task assignments. However, there is currently no centralized system to assign and/or track the progress of tasks that need to be completed before the meeting. Further, invitees must often scramble when they realize that tasks were assigned for completion before the meeting.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

This patent document relates generally to systems and methods for automatically generating a calendar event for a task, wherein the task is associating with an upcoming meeting.

In one aspect, a computer-implemented method of automatically generating a calendar event for a task comprises the following steps: receiving a first indication to create a meeting with at least one invitee; receiving an agenda for the meeting, wherein the agenda includes at least one task assigned to the at least one invitee, and wherein the task is associated with a deadline; automatically generating a task invitation to the at least one invitee to complete the at least one task, the task invitation including one or more selectable time slots, wherein each of the one or more selectable time slots occurs before the deadline; and sending the meeting invitation and the task invitation to the at least one invitee.

In another aspect, a computer-implemented method of automatically generating a calendar event for a task comprises: receiving a meeting invitation for a meeting, wherein the meeting invitation includes an agenda for the meeting, identifying at least one task assigned to an invitee, scanning the invitee's calendar to identify one or more time slots for completing the at least one task; generating a task invitation to complete the at least one task, the task invitation including the one or more time slots, wherein each of the one or more times slots occurs before the meeting; receiving a selection of at least one time slot; and based on the selected time slot, automatically adding a calendar event to the invitee's calendar for completing the at least one task prior to the meeting.

In still another aspect, a computer-implemented method for automatically generating a calendar event for a task comprises: receiving a meeting invitation for a meeting, wherein the meeting invitation includes an agenda for the meeting, identifying at least one task assigned to an invitee, scanning the invitee's calendar to identify one or more time slots to complete the at least one task; generating a task invitation to complete the at least one task, the task invitation including a time slot, wherein the time slot occurs before the meeting; and automatically adding a calendar event to the invitee's calendar during the time slot to complete the at least one task prior to the meeting.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description, which follows and, in part, will be apparent from the description, or may be learned by practice of the disclosure.

### BRIEF DESCRIPTION OF THE DRAWINGS

FIG. 1 is a block-diagram of an exemplary system including a computing device consistent with an embodiment of the present invention;

FIG. 2 is a block-diagram illustrating example physical components of a computing device with which aspects of the disclosure may be practiced.

FIG. 3 is an example flowchart of a method according to an embodiment.

FIG. 4 is an example flowchart of a method according to an embodiment.

FIG. 5 is an example embodiment of a user interface of a calendar scheduling application.

FIG. 6 is an example embodiment of an electronic calendar application feature.

FIG. 7 is an example embodiment of a user interface of a calendar application.

FIGS. 8A and 8B are simplified block diagrams of a mobile computing device with which aspects of the present disclosure may be practiced.

FIG. 9 illustrates a tablet-computing device for executing one or more aspects of the present disclosure.

### DETAILED DESCRIPTION

In the following detailed description, references are made to the accompanying drawings that form a part hereof, and in which are shown by way of illustrations, specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

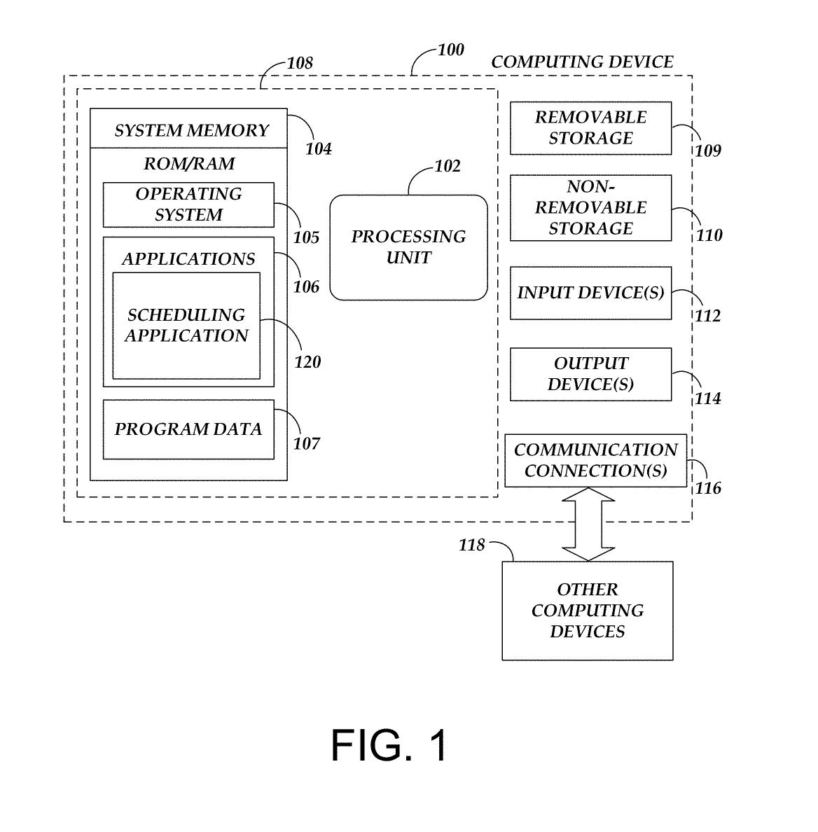

With reference to FIG. 1, one exemplary system includes a computing device, such as computing device 100. In a basic configuration, computing device 100 may include at least one processing unit 102 and a system memory 104. Depending on the configuration and type of computing device, system memory 104 may be volatile (such as RAM), non-volatile (such as ROM, flash memory, etc.) or some combination. System memory 104 may include an operating system 105, one or more applications 106, and may include a program data 107. In one embodiment, applications 106 may include a scheduling application 120. However, embodiments of the invention may be practiced in conjunction with a calendar program, a graphics library, an operating system, or any application program, and is not limited to any particular application or system. This basic configuration is illustrated in FIG. 1 by those components within a dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by a removable storage 109 and a non-removable storage 110. Computer storage media may include volatile and non-volatile, removable and non-removable media implemented in any method or technology for storage of information, such as computer readable instructions, data structures, program modules, or other data. System memory 104, removable storage 109, and non-removable storage 110 are all examples of computer storage media. Computer storage media may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. The aforementioned devices are exemplary and others may be used.

Computing device 100 may also contain a communication connection(s) 116 that may allow device 100 to communicate with other computing devices 118, such as over a network in a distributed computing environment, for example, an intranet or the Internet. Communication connection(s) 116 is one example of communication media. Communication media may typically be embodied by computer readable instructions, data structures, program modules, or other data in a modulated data signal, such as a carrier wave or other transport mechanism, and includes any information delivery media. The term computer readable media as used herein may include both storage media and communication media.

A number of program modules and data files may be stored in system memory 104 of computing device 100, including an operating system 105 suitable for controlling the operation of a networked personal computer, such as the WINDOWS operating systems from MICROSOFT CORPORATION of Redmond, Wash. System memory 104 may also store one or more program modules, such as scheduling application 120, and others described below. While executing on processing unit 102 or other computing devices 118, scheduling application 120 may perform processes including, for example, one or more of the stages of the methods described below. The aforementioned process is exemplary, and processing unit 102 or other computing devices 118 may perform other processes. Other applications 106 that may be used in accordance with embodiments of the present invention may include calendaring applications, electronic mail and contacts applications, word processing applications, spreadsheet applications, database applications, slide presentation applications, drawing or computer-aided application programs, etc.

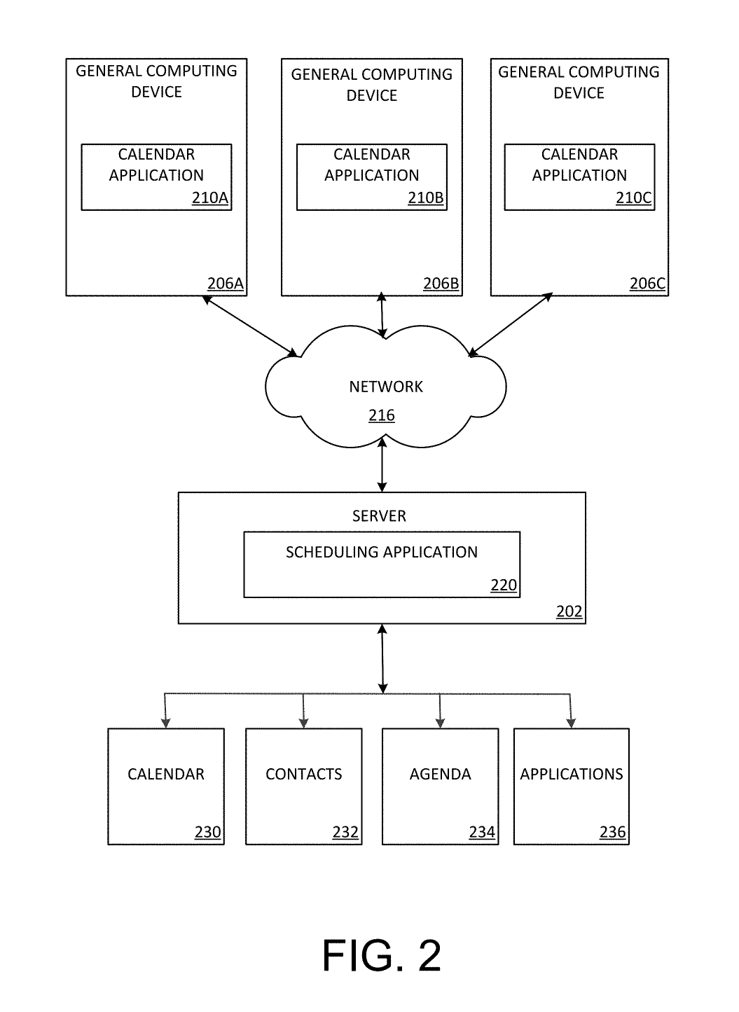

FIG. 2 illustrates one aspect of the architecture of a system for processing data received at a computing system from a remote source, such as a general computing device 100 (e.g., personal computer), as described above. Content displayed at server device 202 may be stored in different communication channels or other storage types. For example, various applications may be accessed by server 202 for communicating with scheduling application 220. For example, applications include calendar application 230, contacts application 232, agenda application 234, and other applications 236. Other applications 236 include word processing applications, spreadsheet applications, database applications, slide presentation applications, drawing or computer-aided application programs. The server device 202 may provide data to and from a computing device such as at least one general computing device 206. By way of example, the computer system described above with respect to FIG. 1 may be embodied in a general computing device 206, such as a personal computer, a tablet-computing device and/or a mobile computing device (e.g., a smart phone). Any of these embodiments of the computing devices may communicate with server 202 to schedule a meeting including assigning tasks to invitees, as described herein.

FIG. 2 is a block diagram illustrating a networked computing environment including the use of a scheduling tool, such as calendar application 210 and agenda application 234, according to one embodiment. As noted above, a scheduling tool may programmatically perform various meeting related activities. In some embodiments, a meeting organizer or other user planning a meeting may use a meeting tool, such as calendar application 210, to plan and schedule a meeting with an agenda that includes at least one task to be completed by an invitee. Thus, multiple devices, such as server 202 and general computing devices 206, are capable of communicating, so that a meeting with an agenda created by a meeting organizer may be received and added to the calendars of the invitees and so that a time slot for completing a task prior to the meeting (or some other deadline) may be added to the calendar of at least one invitee.

A calendar application 210 (e.g., calendar application 210A operating on computing device 206A, calendar application 210B operating on computing device 206B, or calendar application 210C operating on computing device 206C) may be in communication with a scheduling application 220, wherein scheduling application 220 may be a centralized calendar application hosted on a server. For example, a first calendar application 210A of a meeting organizer may create and send a meeting invitation to an invitee, and a calendar application 210B of the invitee may add the meeting to the invitee's calendar. Either calendar application 210A or calendar application 210B may create and send a task invitation to the invitee when a meeting organizer has assigned a task to the invitee. In some aspects, calendar application 210B of the invitee may be better equipped to evaluate the invitee's calendar to identify available time slots for completing a task than calendar application 210A of the meeting organizer.

In an example, one or more task items listed in the agenda associated with a meeting may be assigned to at least one invitee. For example, the invitee's calendar application 210B may scan a meeting invitation to determine if the invitee has been assigned a task to complete before the meeting, and then the calendar application 210B may create a task invitation for the invitee to complete the task. In an embodiment, the invitee may be tagged in association with the task. For example, an @mention within the agenda may be used to assign a task to an invitee. Tagging an invitee with an @mention in the agenda may signify to the calendar application 210A or the calendar application 210B to send a task invite to the invitee for completing the task before the meeting. In aspects, either the calendar application 210A of the meeting organizer or the calendar application 210B of the invitee can function to scan the agenda for an @mention for that invitee. Once an @mention is found for that invitee, either the calendar application 210A of the meeting organizer or the calendar application 210B of the invitee can generate a task invitation.

As explained above, calendar application 210B is capable of performing meeting-related activities, such as coordinating an invitee's calendar appointments and task invites. For example, the invitee's calendar application 210B may be configured to programmatically determine the availability of the invitee to attend meetings and complete tasks. The calendar application 210B of the invitee may be configured to programmatically determine the availability of the invitee for scheduling a time slot to complete a task and may facilitate automatically adding a calendar item to the invitee's calendar to complete the task.

As should be appreciated, FIG. 2 is described for purposes of illustrating the present methods and systems and is not intended to limit the disclosure to a particular sequence of steps or a particular combination of hardware or software components.

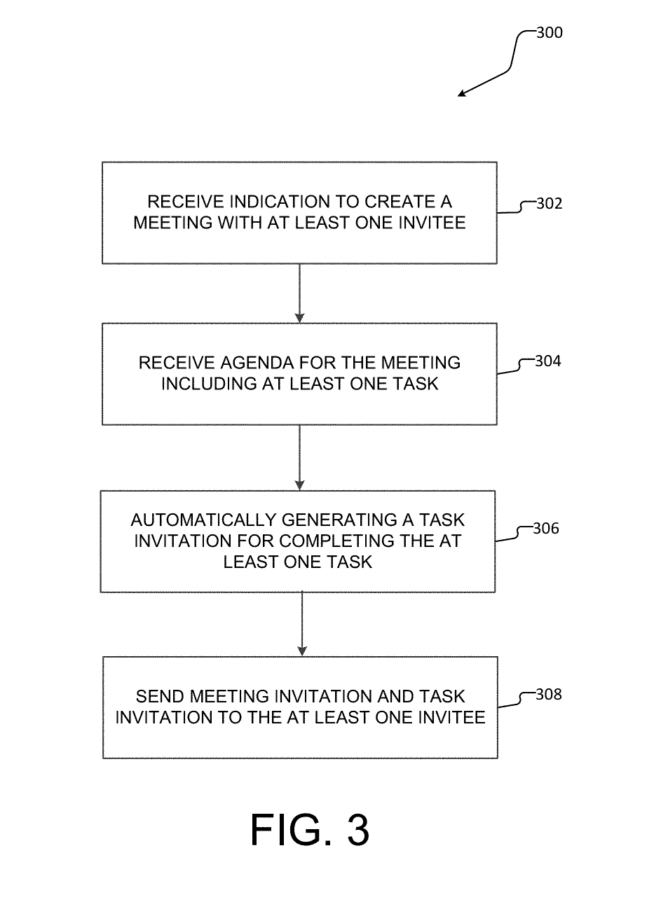

FIG. 3 illustrates a flowchart of an example embodiment of a method of generating and sending a meeting invitation that includes an agenda with at least one task assigned to an invitee. The method 300 includes inviting at least one invitee to a meeting and assigning at least one task to the invitee. At create operation 302, an indication to create a meeting is received. In aspects, the meeting may include at least one invitee. In an example embodiment, more than one invitee is invited to the meeting. The meeting organizer may or may not be an invitee. In an embodiment, the meeting may be initiated automatically, such as a recurring event. Alternatively, a meeting organizer may manually initiate the meeting by launching a meeting invitation user interface and inputting meeting details, such as start time, end time, date, location, invitees, etc.

At receive agenda operation 304, an agenda for the meeting is received. For example, the agenda may be received from the meeting organizer by a calendar application and may include at least one task that is assigned to at least one invitee. In an example embodiment, the agenda may include multiple tasks that are each assigned to one or more invitees, who may be the same or different. Assigning a task to an invitee may include electronically linking the invitee to the task. An example of electronically linking an invitee to a task includes tagging an invitee in association with the task. For example, an @mention may be used to assign an invitee to complete at least one task on the agenda.

At generate operation 306, a task invitation may be created for completing the task. In some cases, tagging an invitee with an @mention in the agenda may signify to the calendar application of the meeting organizer to create a task invitation to the invitee for completing the task before the meeting. Other symbols may be used to associate an invitee with a task, such as a #mention, or other similar symbols. As the calendaring application of the meeting organizer may or may not have access to the invitee's calendar, the task invitation may be generated according to one or more rules. For instance, if the task is common (e.g., the calendar application has access to crowd-sourced or user-specific data regarding the task), the task invitation may be generated based on such data. For instance, data accessible to the calendar application may indicate that a task associated with completing a PowerPoint® presentation may generally be scheduled for about two hours. Moreover, it may be determined that the particular invitee generally schedules tasks on the day before the task is due. Accordingly, in this example, a task invitation may be generated and sent to the invitee for a two-hour time slot the day before the meeting. If the calendar application of the meeting organizer has access to the invitee's calendar, the calendar application may scan the invitee's schedule for available two-hour time slots on the day before the meeting. Otherwise, the calendar application may send the task invitation to the invitee and the invitee may accept or reschedule the calendar item as the invitee's schedule allows.

At send operation 308, an indication to send the meeting invitation to the at least one invitee may be received. The meeting invitation may include the agenda, where at least one invitee is tagged with at least one task. When the indication to send the meeting invitation is received, the task invitation may also be sent to the invitee. Alternatively, the meeting invitation to the at least one invitee may include the task invitation. In an embodiment, the meeting invitation sent to each invitee is the same. In an alternative embodiment, invitees who are assigned a task are sent a different invitation than invitees who have not been assigned a task. If the meeting invitation does not include the task invitation, the meeting invitation may include a notification to the invitee that a task has been assigned for completion before the meeting occurs.

As should be appreciated, FIG. 3 is described for purposes of illustrating the present methods and systems and is not intended to limit the disclosure to a particular sequence of steps or a particular combination of hardware or software components.

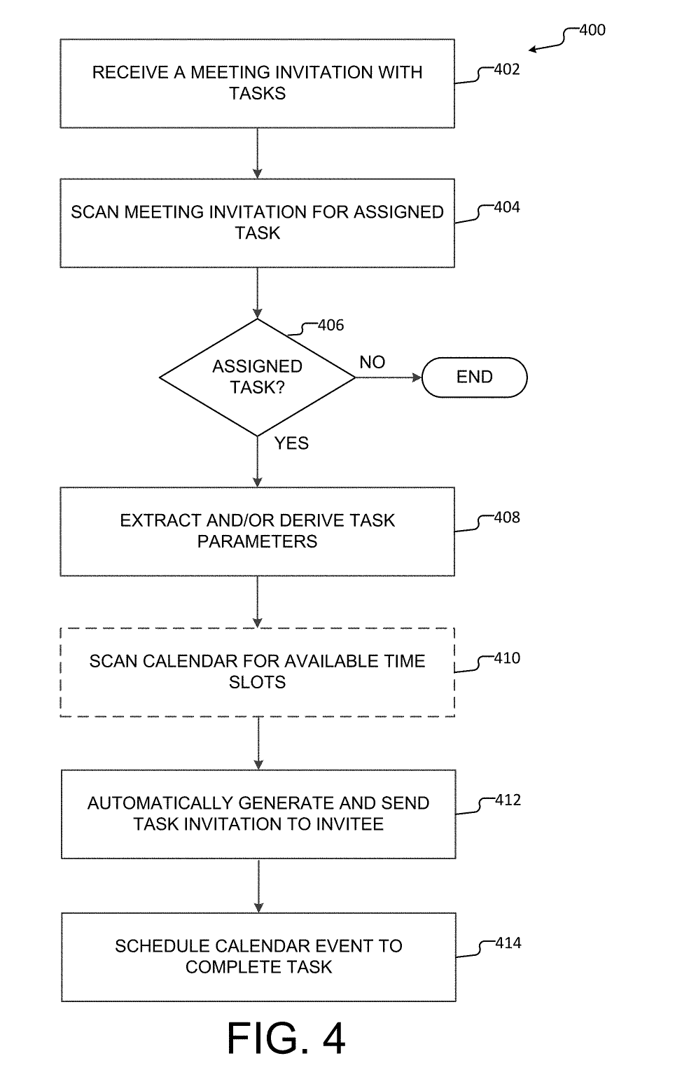

FIG. 4 illustrates a flowchart of an example embodiment of a method for automatically generating a task invitation. The method 400 includes receiving a meeting invitation that includes an agenda (or a task list). In an example embodiment, more than one invitee is invited to the meeting and method 400 may be performed independently by a calendar application 210B associated with a first invitee and a calendar application 210C associated with a second invitee.

At receive operation 402, an invitee (e.g., either the first invitee or the second invitee) may receive a meeting invitation that includes an agenda. The agenda may or may not include a tasks assigned to each invitee. In some cases, each task may be associated with a deadline, which may be the meeting date and time (collectively, “meeting time”) or some other date and time. In an embodiment, the agenda includes multiple tasks that are each assigned to one or more invitees, who may be the same or different. As explained above, a task may be electronically linked to an invitee by tagging the invitee in association with the task. For example, an @mention to the invitee within the agenda may be used to assign the task to the invitee. Tagging an invitee with an @mention signifies to the system to send a calendar task item to complete the task before the meeting. Other symbols may be used to associate an invitee with a task, such as a #mention, or other similar symbols.

At scanning operation 404, the meeting invitation may be scanned for an agenda (or other task listing) and the agenda may then be scanned for an @mention (or other similar symbol) that tags an invitee with a task. In aspects, the calendar application of an invitee may scan the meeting invitation for an agenda (or other task listing).

As used here, “scanning” the meeting invitation may comprise programmatically examining the meeting invitation to identify an agenda or other listing of task, and then scanning the agenda for tags, such as @mentions, identifying the invitee. For example, the calendar application (or an associated application) of the invitee may scan the meeting invitation for embedded content, textual or graphical content, attached documents, user callouts (e.g., @mentions), and the like. The calendar application (or an associated application) may implement any suitable technique for scanning the meeting invitation, including common techniques presently known or techniques developed in the future. Traditionally, a common approach to extract structured data from a document (e.g., the meeting invitation) uses a “wrapper” that relies on the structure of the document to extract specific pieces of information. Recent advances in extraction techniques rely on semi-structured information extraction, natural language processing (NLP) techniques, and semantic tagging and shallow parsing to build relationships between various components within a sentence. These approaches utilize recognizable keywords (e.g., an @mention) to identify specific relationships, such as tagging the invitee with a task. In aspects, any of the techniques described above, or any other technique presently known or developed in the future may be used by the calendar application to scan the meeting invitation.

At determination operation 406, it may be determined whether the invitee was tagged with a task for the meeting. For example, based on scanning the meeting invitation, the calendar application may determine whether the invitee has been tagged with a task. If an @mention was identified within the agenda for the invitee, the invitee's calendar application may proceed to parameter operation 408 to extract and/or derive task parameters for the task. Otherwise, the method may terminate.

At parameter operation 408, the calendar application of the invitee may extract and/or derive parameters for the task. For example, upon identifying an @mention tagging the invitee with a task in the agenda, the calendar application may extract additional information regarding the task, such as a description of the task (e.g., “present PowerPoint,” “provide update on launch,” “forward approved copy for brochure,” etc.), documents associated with the task (e.g., attached to the meeting request or otherwise available to the calendar application), a deadline associated with the task (e.g., the meeting time or some other deadline), other invitees assigned to the task, etc. Based on the extracted parameters for the task, the calendaring application may then derive or estimate additional parameters for the task. For instance, if the task description is “present PowerPoint,” the calendaring application may consult crowd-sourced data or invitee-specific data to determine an estimated time to complete the task. In aspects, if invitee-specific data is available, the calendaring application may prioritize such data above crowd-sourced data. That is, if the crowd-sourced data indicates that users generally spend 3 hours to prepare a PowerPoint presentation, but the invitee generally spends 2½ hours, the calendaring application may discount the crowd-sourced data and identify a completion time of 2½ hours for the task. Alternatively, invitee-specific data may be unavailable and the calendaring application may rely on the crowd-sourced data.

In aspects, the invitee-specific and/or crowd-sourced data may be drawn from the calendaring application itself or other applications. For example, a completion time for a task may be based on historical calendar or task items (e.g., an amount of time scheduled in the invitee's calendar or in the calendars of other users for similar tasks), or based on an actual time by the invitee or other users that was spent preparing and editing a document (as tracked by a presentation application, a spreadsheet application, a word-processing application, etc.). Some tasks may involve publicly available completion times (e.g., based on posted times for completion such as advertisements or other marketing or invoicing sources). As should be appreciated, the calendaring application may rely on any data available for deriving or estimating a completion time for a task.

At time slot operation 410, the calendar application may scan the invitee's calendar for available time slots prior to the deadline for completing the task. An available or open time slot is a time slot for which the invitee does not have a scheduled calendar item. In some cases, e.g., where the estimated completion time for the task may be several hours, the calendar application may divide the completion time into sub-blocks of time. For example, if the completion time is estimated to be three hours, the calendaring application may evaluate the invitee's schedule for three 1-hour time slots for completing the task. Alternatively, the calendaring application may evaluate the invitee's calendar to identify available time slots corresponding to the completion time, in this case, 3-hour time slots. In some cases, the calendaring application may identify a single suggested time slot (or sub-time slots) corresponding to the completion time; in other cases, the calendaring application may identify multiple alternative time slots (or sub-time slots) corresponding to the completion time.

At generate operation 412, the invitee's calendar application may generate and send a task invitation to the invitee for completing the task. For example, based on the extracted and/or derived parameters (collectively, parameters) for the task, and the available time slots identified in the invitee's calendar, the calendaring application may generate a task invitation. Based on the example above, the calendaring application may generate a task invitation by automatically populating a subject field with “Complete PowerPoint,” populating a date field based on an available time slot prior to the task deadline, and populating a start time and an end time based on the completion time. In some cases, e.g., where multiple invitees were assigned to the same task (particularly if the task requires the invitees to work together), the calendaring application may further populate additional invitees in an invitee field for the task invitation. For multiple invitees, the calendaring application may or may not have access to the calendars of the other invitees. If access is available, available time slots may be coordinated across the multiple invitee calendars; otherwise, the calendaring application may schedule the task during a time that is available for the first invitee (i.e., the invitee associated with the calendaring application) and the other invitees (i.e., second set of invitees) may accept the invitation or propose alternative times for the task invitation. In some cases, as identified above, the calendaring application may provide alternative time slots within the task invitation. For instance, the alternative time slots may be provided as options for selection within the task invitation. Alternatively, the calendaring application may populate the task invitation with a single time slot.

Upon generating the task invitation, the calendar application may send the task invitation to the invitee (or the invitees). In aspects, the task invitation may be sent to the invitee as an email. Alternatively, the task invitation may be provided in a popup window of the invitee's calendar when the meeting invitation is received by the calendaring application. In still other examples, the task invitation may be sent to the

At schedule operation 414, the calendar application may schedule a calendar event to complete the task. In aspects, the calendar application may schedule the task in response to receiving an “acceptance” from the invitee. In other aspects, the calendar application may schedule the task in response to receiving a selection of a time slot. In still other aspects, the calendar application may automatically schedule the task when the meeting invitation is received and analyzed. In this case, after the task invitation is generated at generate operation 412, the task invitation may be automatically converted to the calendar event and applied to the invitee's calendar rather than being sent to the invitee. In aspects, the calendar event scheduled to complete the task may include details related to the task, and can include a link to the meeting and/or other application information. As the calendar event to complete the task occurs before the meeting (or the deadline if different), the invitee will have ample time to complete the task. Moreover, as the task invitation is automatically generated upon detecting that the invitee has been assigned a task, the invitee does not need to be concerned with reviewing each meeting invitation as it is received in order to manually schedule tasks. In an embodiment, a single time slot is needed to complete the task and a single calendar event is added to the invitee's calendar. In another embodiment, a plurality of time slots are needed to complete the task, so a plurality of calendar events are added to the invitee's calendar.

As should be appreciated, FIG. 4 is described for purposes of illustrating the present methods and systems and is not intended to limit the disclosure to a particular sequence of steps or a particular combination of hardware or software components. While method 400 is described from the perspective of a calendaring application associated with at least one invitee, method 400 could equally well be performed by a calendaring application hosted by a server or in a cloud-computing environment. Moreover, some or all of the operations could be performed by a calendaring application associated with the meeting organizer, particularly if such calendaring application has access to the calendars of the one or more invitees.

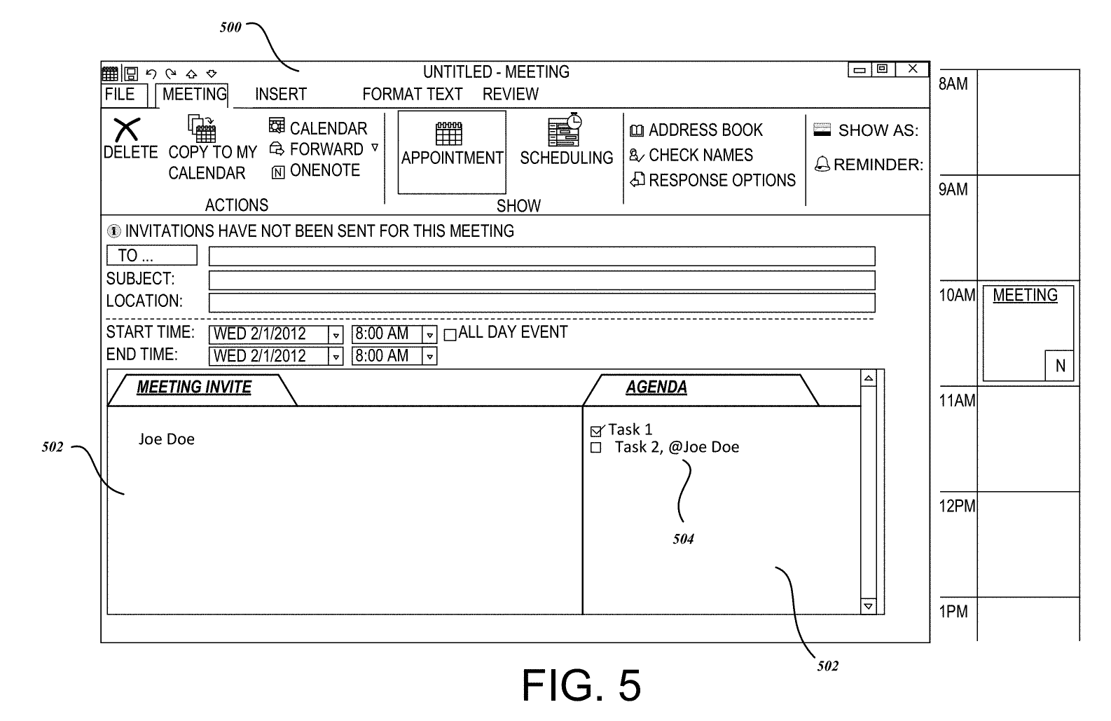

FIG. 5 depicts a meeting invitation 500 that includes an invite tab 502 for selecting and entering invitees and details regarding the meeting that are sent to the invitees. Meeting invitation 500 also includes an agenda tab 502, where a meeting organizer can list task items that are associated with the meeting. For example, the meeting organizer can tag invitees with an @mention 504 in order to assign a task. In aspects, tagging an invitee may associate a task item with that invitee. In some aspects, tagging an invitee in the agenda tab 502 may automatically send the invitee a task invitation for completing the assigned task.

As should be appreciated, FIG. 5 is described for purposes of illustrating the present methods and systems and is not intended to limit the disclosure to a particular sequence of steps or a particular combination of hardware or software components.

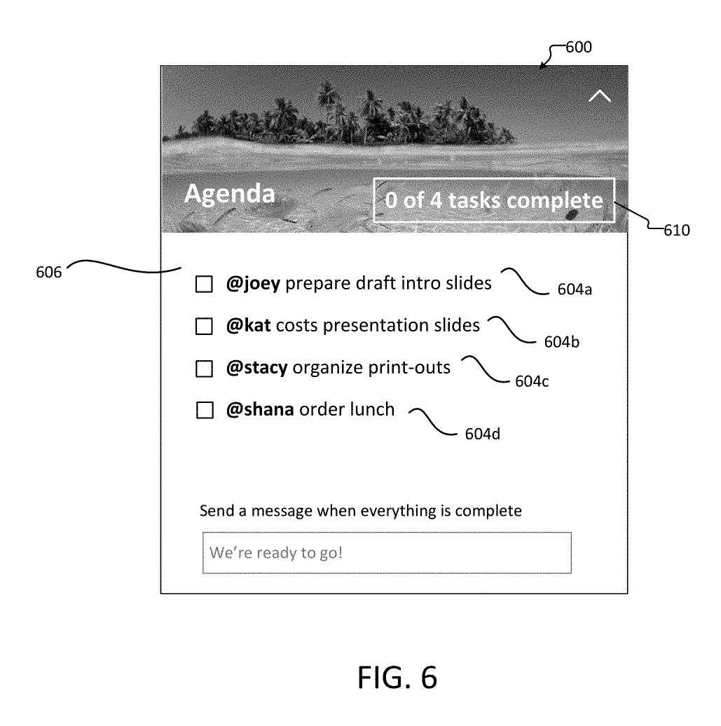

FIG. 6 illustrates an expanded view of an agenda tab 600, according to a first example embodiment. Agenda tab 600 displays the task list 606 summarized by status indicator 610. As shown, task list 606 includes four tasks: a first task 604a specifying “@joey prepare draft intro slides”; a second task 604b specifying “@kat costs presentation slides”; a third task 604c specifying “@stacy organize print-outs”; and a fourth task 604d specifying “@shana order lunch.” As reflected by status indicator 610, none of the tasks associated with task list 606 have been completed, as indicated by empty boxes adjacent to each task.

In an example embodiment, expanded agenda tab 600 provides for sending a custom message when each task of task list 606 is completed. In aspects, the custom message may be entered into input field 610. However, as the tasks associated with task list 606 have not yet been completed, input field 610 is not selectable for input (e.g., grayed out). Custom message may be sent to the meeting organizer, or custom message may be sent to all the invitees.

As should be appreciated, the various devices, components, etc., described with respect to FIG. 6 are not intended to limit the systems and methods to the particular components described. Accordingly, additional topology configurations may be used to practice the methods and systems herein and/or some components described may be excluded without departing from the methods and systems disclosed herein.

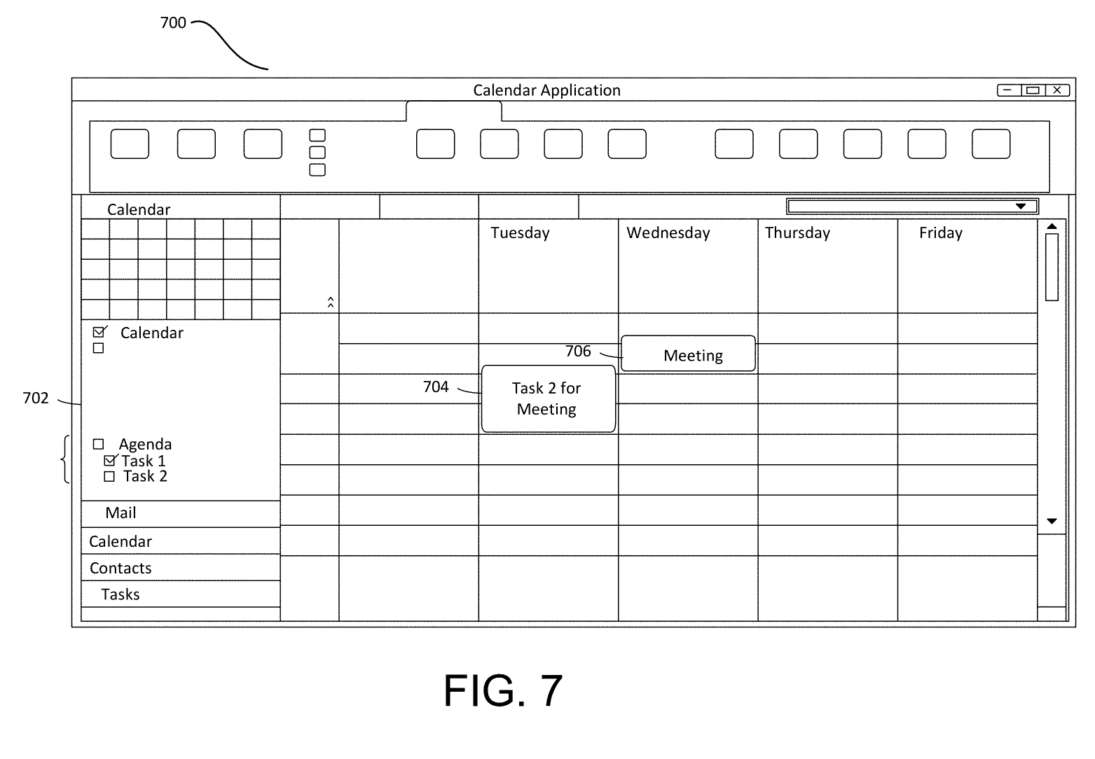

FIG. 7 illustrates a computer-generated screen shot of a task/calendar item user interface 700 for allowing user verification of a recommended task or calendar item. The user interface 700 is illustrative of a user interface component in which text strings classified as task items or calendar items may be presented to a user for acceptance, correction, or replacement. A text box/field 702 is provided for presenting the candidate task or calendar item. In the illustrated embodiment, the invitee has completed task 1 (as shown by the checked box) and the calendar application has scheduled a task item 704 (e.g., calendar event) for task 2 prior to meeting 706.

In an example embodiment, assigning a task to an invitee includes automatically populating a time slot to complete the task in the invitee's calendar, and may also include automatically determining the amount of time to complete the task. That is, the system can evaluate the task and relate the current task to previous tasks to determine the size of the time slot. The system may utilize the invitee's previous completed tasks to determine the time slot. Alternatively, or in addition to, the system may crowd-source data to determine how long the task generally takes to complete. Utilizing crowd-source data may include comparing the calendars of other invitees to determine how long it took to complete the task or similar task.

In an embodiment, more than one invitee may be assigned to the same task. The system can automatically schedule a time slot at the same time for each invitee. The time slot selected is an open time slot for all the invitees and occurs before the meeting. The system may also include an option for one of the invitee to change the time slot, which would automatically change the time slot for the other invitees assigned to the same task.

Further, the time slot details regarding the task may automatically change if the meeting organizer changes the task or the details regarding the task. For example, if a task is no longer required, the meeting organizer may delete the task, and therefore the calendar time slot would be removed from the invitee's calendar. Alternatively, the meeting organizer may change the task, which would be automatically change the task as listed on the invitee's calendar.

In a further embodiment, a system may recommend an agenda or task item. If the meeting organizer accepts the recommended agenda or task item, the recommended agenda or task item is stored and processed, and calendar time slots are added to the associated invitee. If the meeting organizer rejects the recommended agenda or task item, then the recommended agenda or task item is not stored and processed to various users as described above. If desired, the meeting organizer may make corrections to the presented agenda or task item, or the meeting organizer may enter a replacement agenda or task item.

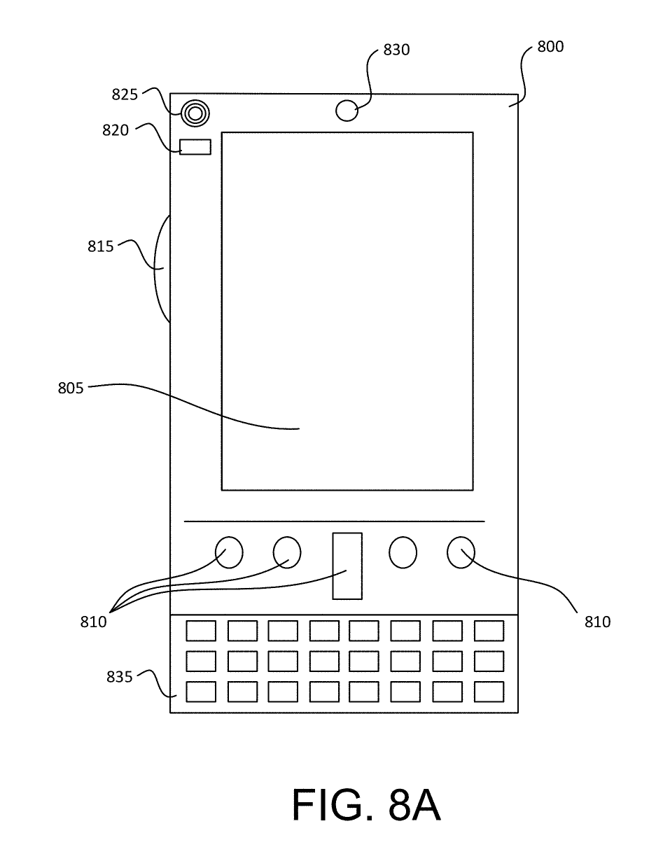

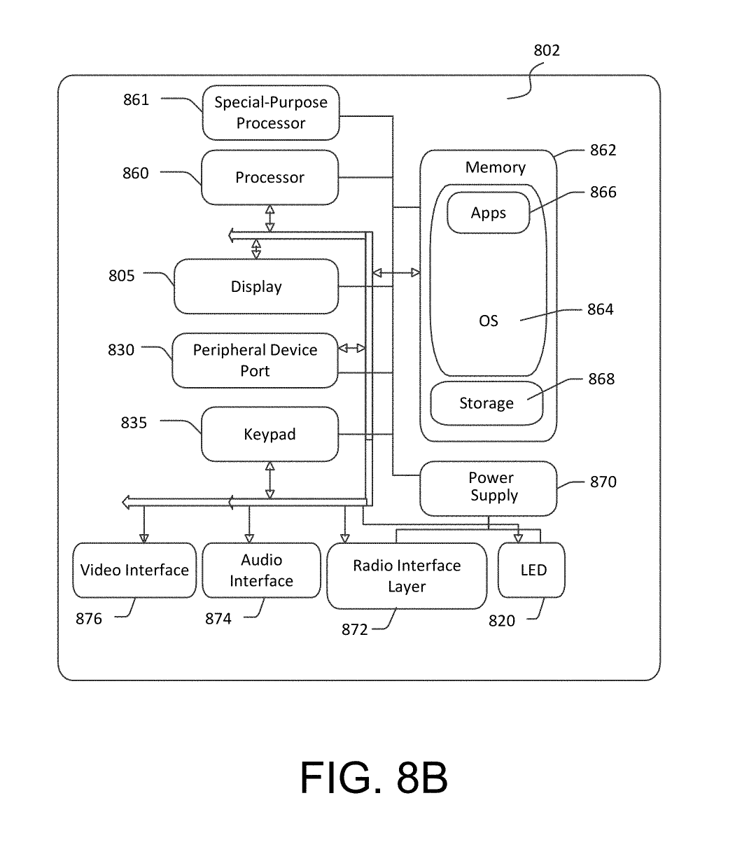

FIGS. 8A and 8B illustrate a mobile computing device 800, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 8A, one aspect of a mobile computing device 800 for implementing the aspects is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative aspects, mobile computing device 800 may incorporate more or less input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display. In various embodiments, the output elements include the display 805 for showing a graphical user interface (GUI), a visual indicator 820 (e.g., a light emitting diode), and/or an audio transducer 825 (e.g., a speaker). In an aspect, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one aspect of a mobile computing device. That is, the mobile computing device 800 can incorporate a system (e.g., an architecture) 802 to implement some aspects. In one embodiment, the system 802 is implemented as a “smart phone” capable of running one or more applications (e.g., browser, e-mail, calendaring, contact managers, messaging clients, games, and media clients/players). In some aspects, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as email or other messages used by an email application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800, including the instructions for providing a consensus determination application as described herein (e.g., message parser, suggestion interpreter, opinion interpreter, and/or consensus presenter, etc.).

The system 802 has a power supply 870, which may be implemented as one or more batteries. The power supply 870 may further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via an audio transducer 825 (e.g., audio transducer 825 illustrated in FIG. 8A). In the illustrated embodiment, the visual indicator 820 is a light emitting diode (LED) and the audio transducer 825 may be a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with embodiments of the present disclosure, the microphone may also serve as an audio sensor to facilitate control of notifications, as will be described below. The system 802 may further include a video interface 876 that enables an operation of peripheral device 830 (e.g., on-board camera) to record still images, video stream, and the like. Audio interface 874, video interface 876, and keyboard 835 may be operated to generate one or more messages as described herein.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio interface layer 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio interface layer 872 or via a distributed computing network. Similarly, such data/information may be readily transferred between computing devices for storage and use according to well-known data/information transfer and storage means, including electronic mail and collaborative data/information sharing systems.

As should be appreciated, FIGS. 8A and 8B are described for purposes of illustrating the present methods and systems and is not intended to limit the disclosure to a particular sequence of steps or a particular combination of hardware or software components.

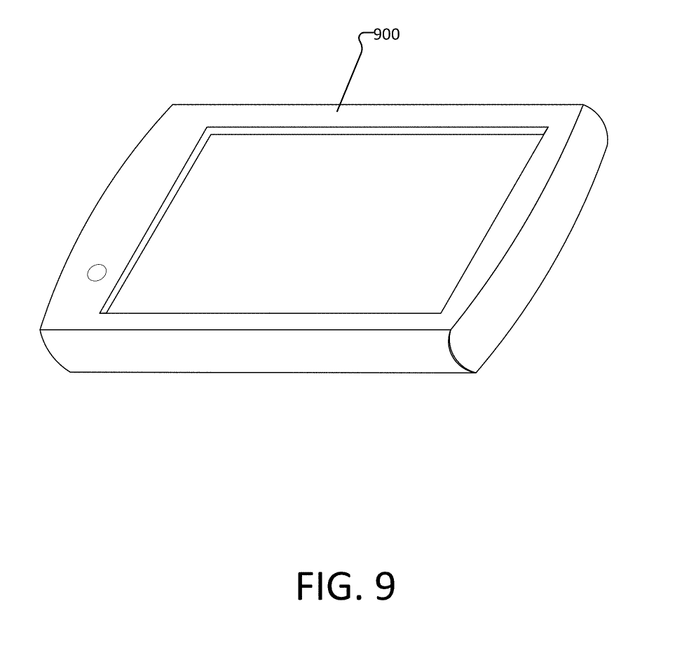

FIG. 9 illustrates an exemplary tablet-computing device 900 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As should be appreciated, FIG. 9 is described for purposes of illustrating the present methods and systems and is not intended to limit the disclosure to a particular sequence of steps or a particular combination of hardware or software components.

The system can evaluate the task and relate to previous tasks to determine the size of the time slot. Can look at a user themselves or crowd-source data to determine how long the task takes to complete. Could look at calendars to see how long others schedule to do the same tasks.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A computer-implemented method of automatically generating a calendar event for a task, comprising:
receiving a first indication to create a meeting with at least one invitee;
receiving an agenda for the meeting, wherein the agenda includes at least one task assigned to the at least one invitee, and wherein the task is associated with a deadline;
automatically generating a task invitation to the at least one invitee to complete the at least one task, the task invitation including one or more selectable time slots, wherein each of the one or more selectable time slots occurs before the deadline; and
sending the meeting invitation and the task invitation to the at least one invitee.

2. The method of claim 1, further comprising:
receiving a selection of one of the one or more selectable time slots; and
scheduling a calendar event for completing the at least one task during the selected time slot in a calendar of the at least one invitee.

3. The method of claim 1, further comprising:
automatically scheduling a calendar event for completing the at least one task during the selected time slot in a calendar of the at least one invitee.

4. The method of claim 1, wherein the agenda is received as an input into an agenda field of the meeting request, attached to the meeting request as a document, or inserted as text into the body of the meeting request.

5. The method of claim 1, wherein the at least one invitee is tagged with the at least one task in the agenda of the meeting.

6. The method of claim 5, wherein tagging the at least one invitee with the at least one task automatically assigns the at least one task to the at least one invitee.

7. The method of claim 5, wherein the tag is an @mention of the at least one invitee.

8. The method of claim 1, wherein the agenda for the meeting comprises a deadline to complete the task.

9. The method of claim 1, wherein the at least one task is a substantial task, and wherein each of the one or more time slots corresponds to a time period that is greater than a time period for a non-substantial task.

10. The method of claim 1, wherein the at least one task can be assigned to more than one invitee, and wherein the scheduled time slot for each invitee to complete the at least one task is the same time slot or a different time slot.

11. A computer-implemented method of automatically generating a calendar event for a task, comprising:
receiving a meeting invitation for a meeting, wherein the meeting invitation includes an agenda for the meeting;
identifying at least one task assigned to an invitee;
scanning the invitee's calendar to identify one or more time slots for completing the at least one task;
generating a task invitation to complete the at least one task, the task invitation including the one or more time slots, wherein each of the one or more time slots occurs before the meeting;
receiving a selection of at least one time slot; and
based on the selected time slot, automatically adding a calendar event to the invitee's calendar for completing the at least one task prior to the meeting.

12. The method of claim 11, wherein the at least one invitee is tagged with the at least one task in the agenda of the meeting.

13. The method of claim 11, further comprising scanning the agenda for tasks assigned to the invitee.

14. The method of claim 12, wherein tagging the at least one invitee with the at least one task automatically assigns the at least one task to the at least one invitee.

15. The method of claim 12, wherein the tag is an @mention of the at least one invitee.

16. The method of claim 11, wherein the at least one task is a substantial task, and wherein each of the one or more time slots corresponds to a time period that is greater than a time period for a non-substantial task.

17. A computer-implemented method of automatically generating a calendar event for a task, comprising:
receiving a meeting invitation for a meeting, wherein the meeting invitation includes an agenda for the meeting;
identifying at least one task assigned to an invitee, scanning the invitee's calendar to identify one or more time slots to complete the at least one task;
generating a task invitation to complete the at least one task, the task invitation including a time slot, wherein the time slot occurs before the meeting; and
automatically adding a calendar event to the invitee's calendar during the time slot to complete the at least one task prior to the meeting.

18. The method of claim 17, wherein the at least one invitee is tagged with the at least one task in the agenda of the meeting.

19. The method of claim 18, wherein tagging the at least one invitee with the at least one task automatically assigns the at least one task to the at least one invitee.

20. The method of claim 18, wherein the tag is an @mention of the at least one invitee.
